(19) United States
(12) Patent Application Publication
(10) Pub. No.: US 2007/0022950 A1
(43) Pub. Date: Feb. 1, 2007

(54) Autocycle universal stand

(76) Inventor: William A. Livingston, Buffalo, SC (US)

Correspondence Address: DORITY & MANNING, P.A., POST OFFICE BOX 1449, GREENVILLE, SC, 29602-1449, US

(21) Appl. No.: 11/183,570

(22) Filed: Jul. 18, 2005

(51) Int. Cl. A47K 1/04; B05C 21/00

(52) U.S. Cl. 118/500; 248/128; 248/129

(57) ABSTRACT

A stand for supporting vehicle parts for painting is provided. The stand includes a base and a vertical member attached to the base. A support member is included and is attached to the vertical member. A plurality of fixtures are provided and are attached to the support member and are configured for holding a plurality of vehicle parts in relation to one another so that the vehicle parts are oriented as if in an assembled state.

### BACKGROUND

Painting of automobiles and motorcycles is performed in order to restore or repair the vehicle after excessive age or collision. Additionally, painting of automobiles and motorcycles is conducted when the owner desires a new look for the vehicle. In order to achieve a high quality paint job, various parts of the automobile or motorcycle must be disassembled and painted individually from other parts. Individual painting of parts may be desirable in that inside edges and areas are capable of being accessed so that all surfaces of the part that are capable of being viewed are painted. Further, it is sometimes the case that the painter will be better able to paint parts that are disassembled as the parts can be more easily manipulated and illuminated for easier viewing.

Vehicle parts are often suspended from the ceiling, or other structure, by wires or the like for painting. An arrangement of this sort may be problematic in that the suspension cannot easily be removed and put out of the way once painting is completed. Additionally, different vehicle parts may not be capable of being held by a single suspension arrangement. Finally, vehicle parts that are suspended have a tendency to rotate during painting, thus requiring other wires to be connected to the vehicle parts from the floor to resist rotation.

Vehicle parts have also been placed on stands that are equipped with a pivoting feature that allow for a section of the stand holding the part to be pivoted during use so that spray hoses and the like do not become entangled. Further arrangements exist in wooden crates or posts that hold vehicle parts during painting. These arrangements are sometimes rotatable so that the vehicle part may be spun to afford the technician access to all or a majority of the area to be painted while allowing the technician to remain at a stationary location.

Vehicle parts are often painted with designs through the use of an airbrush. Designs are often done so that they cover and thus extend to more than one vehicle part. For example, a design such as a flame, animal, or color scheme may extend from the gas tank of a motorcycle to a side fairing. In these instances, the different vehicle parts are individually painted such that one part is worked on while another is placed at a different location. The technician runs the risk that mistakes will be made in painting a design that will not line up when the two vehicle parts are ultimately assembled.

### SUMMARY OF THE INVENTION

Various features and advantages of the invention will be set forth in part in the following description, or may be obvious from the description, or may be learned from practice of the invention.

The present invention provides for a stand that is capable of holding vehicle parts that are to be painted. The stand may be configured to hold a plurality of vehicle parts in relation to one another so that the vehicle parts are oriented as if in an assembled state. In this manner, the quality of painting of the vehicle parts is increased as the technician will be more easily able to view and paint designs, color schemes and the like that extend from one of the vehicle parts to another. The stand may be used to hold parts from any type of vehicle, for example from automobiles or motorcycles. Additionally, a stand is provided that includes a support member that has an elongated length in the horizontal direction and is fixed with respect to a base and a vertical member so as to be capable of holding one or more vehicle parts thereon.

The present invention provides for a stand for supporting vehicle parts for painting that includes a base and a vehicle member attached to the base. A support member is attached to the vertical member and a plurality of fixtures are attached to the support member. The fixtures are configured for holding a plurality of vehicle parts in relation to one another so that the vehicle parts are oriented as if in an assembled state.

Also provided is a stand as previously discussed in which the fixtures are spaced with respect to one another so as to be configured for holding the plurality of vehicle parts in relation to one another so that the vehicle parts are oriented and spaced with respect to one another as if in an assembled state.

Also provided for in accordance with one exemplary embodiment is a stand as previously discussed in which the support member has an elongated length in the horizontal direction.

A further exemplary embodiment exists in a stand that includes first and second pivotable members that are pivotably attached to the base so that they are capable of being pivoted with respect thereto. At least one fixture is attached to each of the first and second pivotable members for use in holding the vehicle parts.

Also provided for in accordance with one exemplary embodiment is a stand as previously discussed that further includes a first intermediate member attached to the vertical member and located between the base and the support member. A fixture is attached to the first intermediate member and is configured for holding one of the plurality of vehicle parts in relation to another vehicle part so that the parts are oriented as if in an assembled state. A second intermediate member is also included and is attached to the vertical member and located between the base and the support member. Likewise, a fixture is attached to the second intermediate member and is configured for holding one of the plurality of vehicle parts in relation to another so that the vehicle parts are oriented as if in an assembled state.

The present invention also includes an exemplary embodiment as previously discussed in which the plurality of fixtures are adjustable on the support member.

The present invention also provides a stand for supporting a vehicle part for painting that includes a base and a vertical member attached to the base so that the orientation of the vertical member is fixed with respect to the base. A support member is also included and is attached to the vertical member so that the orientation of the support member is fixed with respect to the base and the vertical member. The support member has an elongated length in the horizontal direction. A plurality of fixtures are present and are attached to the support member and are configured for holding a vehicle part for painting.

The present invention also provides a stand as immediately discussed in which the plurality of fixtures are configured for holding a plurality of vehicle parts in relation to one another so that the vehicle parts are oriented as if in an assembled state.

A further exemplary embodiment exists in a stand as immediately discussed in which the plurality of fixtures are spaced with respect to one another so as to be configured for holding the plurality of vehicle parts in relation to one another so that the parts are oriented and spaced with respect to one another as if in an assembled state.

A further exemplary embodiment of the stand exists in which the stand as discussed above includes and holds two mirrors, four door handles, two fenders, one bumper, and one spoiler of an automobile. Further, an exemplary embodiment of the stand exists as discussed above in which a plurality of vehicle parts are included and are held by the stand and are for a motorcycle. The vehicle parts include at least a tank, a side fairing, a front fairing, and a rear section of the motorcycle.

The present invention also provides for a stand for supporting vehicle parts for painting that includes a base and a vertical member attached to the base so that the orientation of the vertical member is fixed with respect to the base. The stand also includes a support member attached to a vertical member so that the orientation of the support member is fixed with respect to the base and the vertical member. A first intermediate member is attached to the vertical member and is located between the base and the support member. Likewise, a second intermediate member is provided and is attached to the vertical member and located between the base and the support member. A plurality of fixtures are included and are attached to the support member, first intermediate member, and second intermediate member. The fixtures are configured for holding a plurality of vehicle parts in relation to one another so that the vehicle parts are oriented in an assembled state.

These and other features, aspects and advantages of the present invention will become better understood with reference to the following description and appended claims. The accompanying drawings, which are incorporated in and constitute part of the specification, illustrate embodiments of the invention, and, together with the description serve to explain the principles of the invention.

### BRIEF DESCRIPTION OF THE DRAWINGS

A full and enabling disclosure of the present invention, including the best mode thereof, directed towards one of ordinary skill in the art, is set forth more particularly in the remainder of the specification, which makes reference to the appended figures in which:

FIG. 1 is a perspective view of a stand having a plurality of fixtures thereon in accordance with one exemplary embodiment.

FIG. 2 is a perspective view of the stand of FIG. 1 that includes a plurality of motorcycle parts held thereon that are oriented with respect to one another so as to be in an assembled state.

FIG. 3 is a perspective close-up view of the base, vertical member and first and second intermediate members of a stand in accordance with one exemplary embodiment.

FIG. 4 is perspective close-up view of the top of the stand that shows the support member and associated fixtures in accordance with one exemplary embodiment.

FIG. 5 is a perspective view of a stand having a plurality of fixtures configured for holding various automotive parts in accordance with one exemplary embodiment.

FIG. 6 is a perspective view of the stand of FIG. 5 in which a plurality of automotive parts are held thereon.

Repeat use of reference characters in the present specification and drawings is intended to represent the same or analogous features or elements of the invention.

### BRIEF DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to about 7 also includes a limit of up to about 5, up to about 3, and up to about 4.5.

A stand 10 is provided and is configured for holding vehicle parts 20 to assist a technician during painting. The stand 10 is configured so that the vehicle parts 20 may be held in relation to one another so that they are oriented as if in an assembled state. This configuration of the stand 10 thus allows for the vehicle parts 20 to be positioned so that designs that extend from one vehicle part 20 to another may be more easily visualized and more accurately painted with fewer mistakes. Additionally, orientation of the vehicle parts 20 as if in an assembled state allows for the technician to more easily visualize how the vehicle parts 20 will ultimately be assembled and thus assists in achieving improved painting. Further, the stand 10 is provided so as to be capable of holding vehicle parts 20 that may be from any type of vehicle, such as a motorcycle or an automobile.

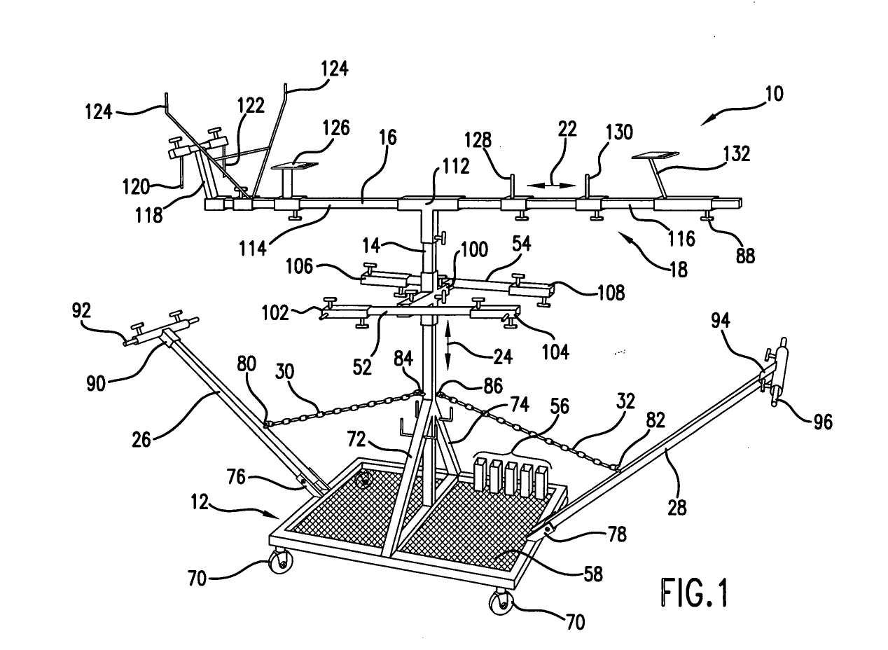

FIG. 1 shows a perspective view of a stand 10 that includes a plurality of members and fixtures 18 that are configured for holding vehicle parts 20 that are motorcycle parts. The stand 10 includes a base 12 that is provided with a plurality of casters 70 for use in supporting and transporting the stand 10. The base 12 includes a frame made from square shaped channel portions that are sufficiently sized to be capable of holding the other portions of the stand 10 along with the supported vehicle parts 20. A grate 58 is included on the base 12 for use in holding various members that may be incorporated into the stand 10. A vertical member 14 may be rigidly attached to the base 12 and may, in accordance with one exemplary embodiment, be fixed to the base 12 so that the orientation of the vertical member 14 and the base 12 does not change. A pair of vertical member supports 72 and 74 are provided and are attached to both the base 12 and the vertical member 14 to help support and stabilize the vertical member 14.

As shown in FIG. 1, the vertical member 14 extends in the vertical direction 24 of the stand 10. A support member 16 is attached to the vertical member 14. In accordance with the exemplary embodiment shown in FIG. 1, the support member 16 has an elongated length in the horizontal direction 22 of the stand 10. Also, in the exemplary embodiment shown, the support member 16 is attached to the vertical member 14 so that the orientation of the support member 16 with respect to both the vertical member 14 and the base 12 does not change.

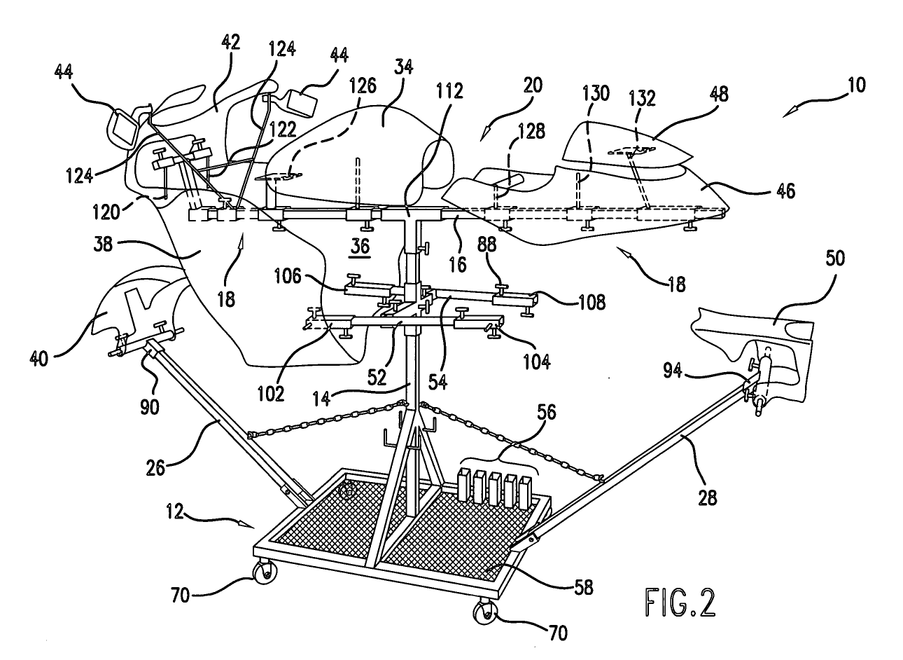

A plurality of fixtures 18 are provided on various portions of the stand 10 and are configured to hold a plurality of vehicle parts 20 as shown in FIG. 2. In this regard, FIG. 2 shows the vehicle parts 20 arranged on the stand 10 so as to be oriented with respect to one another as if in an assembled state. As previously mentioned, this configuration allows the technician to more easily visualize the completed painting of the motorcycle and assists the technician in painting designs that extend from one of the vehicle parts 20 to another. Although it is to be understood that any number of vehicle parts 20 may be placed onto the stand 10 for painting, FIG. 2 shows an exemplary embodiment of the stand 10 in which a right side fairing 36, a left side fairing 38, a front fender 40, a front fairing 42, mirrors 44, a rear section 46, a seat cover 48 and a lower shield 50 of a motorcycle are held.

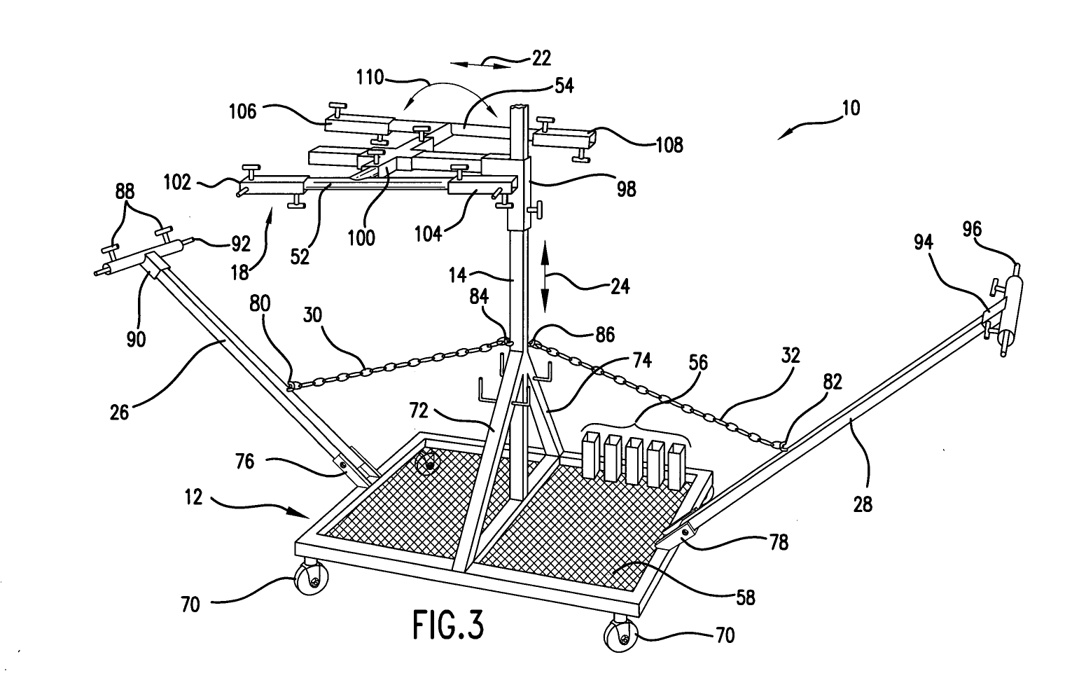

FIG. 3 is a perspective close-up view of the base area of the stand 10 that shows certain components of the stand 10 in more detail. Here, a plurality of holders 56 may be located on the base 12 and may be used for holding various members of the stand 10 that will be later discussed. These members may be removed from the holders 56 when needed for assembly on the stand 10 for the holding of various vehicle parts 20. The holders 56 may be located on one end of the base 12 so as to act as a counter weight to resist tipping of the stand 10 when fully loaded by vehicle parts 20 on one end thereof. However, it is to be understood that the stand 10 may be designed so that the base 12 is of a sufficient size and strength to resist tipping without the need of counter weights such as the holders 56.

The vertical member 14 is shown welded to the base 12. However, it is to be understood that in accordance with other exemplary embodiments, that the vertical member 14 may be connected to the base 12 in a variety of manners known to one having ordinary skill in art. For instance, the vertical member 14 may be bolted, clipped, or threadably received into the base 10. The vertical member 14 may be of any cross-sectional shape. For example, the vertical member 14 may have a cross-section that is square, rectangular, triangular, or circular in shape. The vertical member 14 may have a hollow interior such as when formed by a channel shaped bar, or the vertical member 14 may be solid throughout. As such, various configurations of the vertical member 14 are possible in accordance with various exemplary embodiments. Additionally, the vertical member 14 may be configured to be adjustable in the vertical direction 24 so as to alter the height of the vertical member 14 as needed by the technician when preparing the stand 10 for painting.

FIG. 3 shows a first a pivotable member 26 pivotably attached to the base 12 by way of a pivot bracket 76. The pivot bracket 76 includes an angled bracket attached to the base 12 along with a pin that holds the first pivotable member 26 so as to cause the first pivotable member 26 to be in pivotable engagement with the base 12. The bracket of the pivot bracket 76 limits pivoting of the first pivotable member 26 away from the vertical member 14. Although shown placed in pivotable engagement with the base 12 by way of the pivot bracket 76, it is to be understood that the first pivotable member 26 may be placed into pivotable engagement with the base 12 in a variety of manners as commonly known to one having ordinary skill in the art. For example, a piano hinge may be employed in accordance with one exemplary embodiment to provide the aforementioned pivoting of the first pivotable member 26.

The first pivotable member 26 is shown as being an elongated member having a channel shaped cross-section. As previously discussed with the vertical member 14, the first pivotable member 26 may be configured in a variety of manners. A hook 80 is provided on the first pivotable member 26 at a distance spaced from the pivot bracket 76. A first chain 30 is included and is linked between the hook 80 and a hook 84 located on the vertical member 14. The first chain 30 acts to limit pivoting of the first pivotable member 26 away from the vertical member 14. The technician may change the links on the first chain 30 that engage the hooks 80 or 84 to modify the limit of pivoting of the first pivotable member 26 as desired.

At one end of the first pivotable member 26 a fixture 90 is included in order to effect attachment between the first pivotable member 26 and the lower shield 50 of the motorcycle. As used herein, the word “fixture” is used to describe a member capable of effecting attachment between one or more vehicle parts 20 and the stand 10. It is to be understood that the fixtures shown and described herein are only exemplary embodiments and that other configurations are possible.

Fixture 90 includes an end that is received onto the first pivotable member 26 and a cylindrical portion that is hollow with a pair of wing nuts 88 attached thereon. A threaded rod 92 may be received in the cylindrical section of the fixture 90 and attached thereto through engagement with the wing nuts 88. Corresponding holes or slots that may or may not be threaded on the lower shield 50 may receive the rods 92 for use in holding the lower shield 50 to the first pivotable member 26. In this manner, the lower shield 50 may be held by the first pivotable member 26 and positioned to a desired location for painting.

FIG. 3 also shows a second pivotable member 28 located on an end of the base 12 opposite from the first pivotable member 26. The second pivotable member 28 may be configured in a manner as previously discussed with respect to the first pivotable member 26 and, as such, a detailed explanation is not necessary. A second chain 32, a pivot bracket 78, a hook 82, and a hook 86 may be employed in a manner as previously discussed with respect to the first pivotable member 26 so as to render the second pivotable member 28 pivotable with a limit of pivoting as previously discussed with respect to the first pivotable member 26. At one end of the second pivotable member 28 a fixture 94 may be located and may be arranged in a manner as previously discussed with respect to the fixture 90. In this regard, a rod 96 may be employed and may be received within the front fender 40 to attach the front fender 40 to the second pivotable member 28 to effect a desired positioning and holding of the front fender 40 for painting.

Although shown attached to hooks 84 and 86 on the vertical member 14, the first and second chains 30 and 32 may be attached to any portion of the stand 10 in accordance with other exemplary embodiments. Additionally, separate chains 30 and 32 need not be employed in accordance with other exemplary embodiments. In this instance, a single chain may be employed and may be linked to the hooks 84 and 86. Alternatively, a single chain may be employed and need not be attached to the hooks 84 and 86. Here, the chain may be linked directly from the hook 80 of the first pivotable member 26 and the hook 82 of the second pivotable member 28 so that the pivotable members 26 and 28 are linked to one another.

The stand 10 also includes first and second intermediate members 52 and 54 for use in holding additional vehicle parts 20. A side bar 98 may be selectively positioned onto the vertical member 14 and secured thereon by a wing nut 88. A bracket 100 that is used to hold both the first and second intermediate members 52 and 54 may be selectively positioned onto the side bar 98 and likewise located thereon by a wing nut 88. The side bar 98 thus allows for the first and second intermediate members 52 and 54 to be moved a desired length in the horizontal direction 22 of the stand 10. This arrangement is slightly different than that shown in FIGS. 1 and 2 in which this degree of adjustment in the horizontal direction 22 is not present. The first intermediate member 52 is located at an end of the bracket 100 and secured thereto by a wing nut 88. The connection between the first intermediate member 52 and the bracket 100 may be made so that the first intermediate member 52 is rotatable with respect to the bracket 100. In this regard, the wing nut 88 may be loosened and the first intermediate member 52 may be rotated in a direction 110 that allows for the first intermediate member 52 to pivot in the vertical direction 24 of the stand 10. In this regard, the first intermediate member 52 may have a circular portion that is received within the bracket 100 to enable the desired rotation. In accordance with other exemplary embodiments, however, the first intermediate member 52 is not rotatable with respect to the bracket 100.

The first intermediate member 52 includes fixtures 102 and 104 located on either end. The fixtures 102 and 104 are selectively positionable along the length of the first intermediate member 52 and are fixed thereon through use of wing nuts 88. The fixtures 102 and 104 have bolts or pins located thereon that may receive various vehicle parts 20 to attach the vehicle parts 20 to the first intermediate member 52. The fixtures 102 and 104 may be placed at a desired position upon adjusting the positioning between the side bar 98, bracket 100 and the first intermediate member 52. In accordance with other exemplary embodiments, the first intermediate member 52 may be configured to have more or fewer adjustments in order to position the fixtures 102 and 104 to a desired location.

The second intermediate member 54, that includes fixtures 106 and 108 for holding various vehicle parts 20, may be arranged in a manner similar to the first intermediate member 52 as discussed above. Further, the second intermediate member 54 may be pivotable in direction 110 while the first intermediate member 52 is not pivotable in direction 110 in accordance with one exemplary embodiment. Further, both first and second intermediate members 52 and 54 may be pivotable in direction 110 in accordance with other exemplary embodiments.

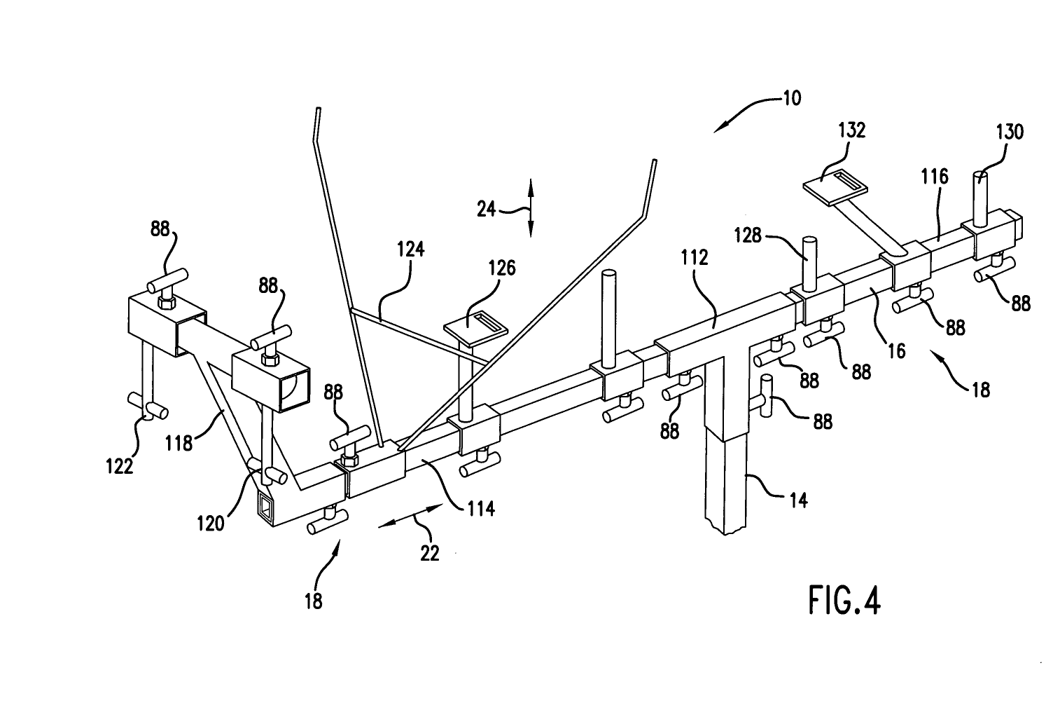

FIG. 4 shows the top of the stand 10 without the vehicle parts 20 attached thereon. A bracket 112 may be placed on the top of the vertical member 14 and secured thereto by a wing nut 88. The support member 16 may be made of a first section 114 and a second sec tion 116. However, in accordance with other exemplary embodiments, the support member 16 may be made of a single piece. The first section 114 may be selectively positioned with respect to the bracket 112 in the horizontal direction 22 and located thereon by a wing nut 88. Likewise, the position of the second section 116 may be selected with respect to the bracket 112 and secured thereon by way of a wing nut 88. The support member 16 may thus be positioned with respect to the vertical member 14 in accordance with certain exemplary embodiments. However, it is to be understood that in accordance with other exemplary embodiments that the support member 16 is stationary with respect to the vertical member 14 and not selectively positionable thereto.

As shown in FIG. 4, the support member 16 does not pivot with respect to the vertical member 14 but instead allows for adjustment in only the horizontal direction 22. The support member 16 may be made of any suitable material and may be variously configured in accordance with certain exemplary embodiments. For example, as with the vertical member 14, the support member 16 may be a circular rod, a rectangular bar, an I-beam, a channel, or other configuration. The support member 16 may extend from one end to the other in the horizontal direction 22 a distance greater than four feet. In accordance with certain exemplary embodiments, the support member 16 may extend in the horizontal direction 22 up to six feet, up to seven feet, or up to eight feet. Additionally, the stand 10 may be arranged so that the support member 16 extends from four to ten feet in the horizontal direction 22 from one end of the support member 16 to the other.

A plurality of fixtures 18 may be located along the length of the support member 16 for use in holding one or more vehicle parts 20 thereon. As shown in FIG. 4, a post 118 may be selectively positioned near one end of the first section 114 and secured thereto by way of a wing nut 88. The post 118 may have an angled section that extends up from the first section 114 and is attached to a circular section that extends past either side of the first section 114. A pair of fixtures 120 and 122 may be attached to the post 118 and secured thereon through the use of wing nuts 88. The fixtures 120 and 122 may be rotatable upon the post 118 or may be configured so as to be non-rotatable therewith. The fixtures 120 and 122 include bolts that are received in corresponding holes in a vehicle part 20 such as the front fairing 42 of a motorcycle to hold the front fairing 42 onto the stand 10.

A mirror fixture 124 may also be selectively positionable along the first section 114 of the support member 116. The position of the mirror fixture 124 along the length of the first section 114 may be fixed by use of a wing nut 88. The mirror fixture 124 has a pair of antennae-like shaped members that extend in the vertical direction 24. Vehicle parts 20, such as mirrors 44, may be attached to the mirror fixture 124 to be held onto the stand 10.

An additional fixture 126 may likewise be selectively positionable along the first section 114. As shown in FIG. 4, fixture 126 includes a vertically extending post and a horizontally extending bracket with a slot therein. A bolt may be disposed through the slot of the fixture 126 and engage a vehicle part 20, such as a tank 34 of a motorcycle, in order to hold the tank 34 onto the stand 10. Although not shown, an additional fixture 18 may be located on the first section 114 for aiding in the holding of the tank 34 by the fixture 126. As such, various exemplary embodiments are included in which any number of fixtures 18 in various styles may be employed on the support member 16 for holding vehicle parts 20 as desired.

The second section 116 of the support member 16 may also have a variety of fixtures 18 located thereon. For example, a pair of fixtures 128 and 130 may be selectively positionable along the length of the second section 116. The fixtures 128 and 130 are provided with wing nuts 88 in order to fix their position onto the second section 116. The fixtures 128 and 130 include bolts that are capable of being received onto a vehicle part 20, such as a rear section 46 of a motorcycle, in order to hold the vehicle part 20 onto the stand 10. FIG. 4 also shows an additional fixture 132 located between fixtures 128 and 130 and likewise selectively positionable along the second section 116. Fixture 132 includes a post that extends in the vertical direction 24 and a flat plate that extends in the horizontal direction 22. The fixture 132 may be angled with respect to the second section 116 or may be substantially perpendicular to the second section 116 in accordance with various exemplary embodiments. The fixture 132 includes a slot through which a bolt may be disposed and subsequently received into a vehicle part 20, such as a seat cover 48 of a motorcycle, for retaining the seat cover 48 onto the stand 10.

Referring back to FIG. 2, placement of various vehicle parts 20 onto the various fixtures 18 of the stand 10 is shown. Here, the front fender 40 is attached to the fixture 90 of the first pivotable member 26, and the lower shield 50 is attached to the fixture 94 of the second pivotable member 28. The left side fairing 38 is attached to the fixture 102 of the first intermediate member 52. Likewise, the right side fairing 36 is attached to the fixture 106 of the second intermediate member 54. The side fairings 36 and 38 may be attached to the stand 10 by use of only the first and second intermediate members 52 and 54, or in an alternative exemplary embodiment, additional fixtures 18 attached to the support member 16 may be included and used to hold the upper portions of the side fairings 36 and 38 to aid in helping the intermediate members 52 and 54 support the side fairings 36 and 38 for their attachment onto the stand 10. Although not shown, additional vehicle parts 20 may be attached to the fixtures 104 and 108 on the intermediate members 52 and 54.

Mirrors 44 may be attached to the mirror fixture 124 in any suitable manner. For example, the mirrors 44 may be bolted, clipped, tied, or friction fit onto the mirror fixture 24. The front fairing 42 is bolted to fixtures 120 and 122. Likewise, the tank 34 is bolted to fixture 126. An additional fixture 18 may be provided on the support member 16 for aiding the fixture 126 and holding the tank 34. The rear section 46 and seat cover 48 of the motorcycle are likewise attached to the stand 10 byway of fixtures 128, 130 and 132.

As shown in FIG. 2, the various parts 20 of the motorcycle are arranged on the stand 10 so as to emulate an assembled state of the motorcycle. In this manner, painting of the motorcycle may be more easily accomplished because the technician will be able to better visualize the various parts 20 of the motorcycle as if they were assembled. The parts 20 may be manipulated on the various fixtures 18 of the stand 10 so that they are spaced from one another as if the parts 10 were assembled. Alternatively, the parts 10 may be spaced away from one another so that they are still in an oriented shape, but are located a distance apart from one another in order to allow for different areas of the parts 20 to be accessed for painting. Orientation of the parts 20 as if in an assembled state may better help the technician paint designs or color schemes that extend from one of the vehicle parts 20 to the other.

It is to be understood that any number of fixtures 18 may be employed for use in holding any number of vehicle parts 20. Additionally, the vehicle parts 20 may be attached to the fixtures 18 in a variety of manners. For example, the vehicle parts 20 may be bolted, clipped, frictionally fit, tied, or snap fit into or on the fixtures 18. Additionally, the vehicle parts 20 may simply rest on the fixtures 18 in accordance with various exemplary embodiments.

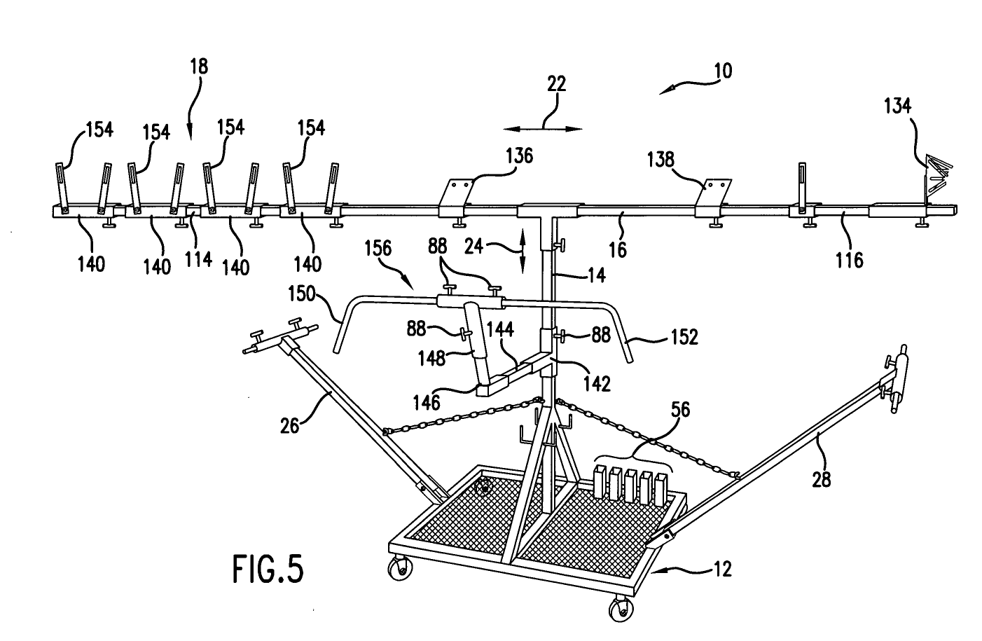

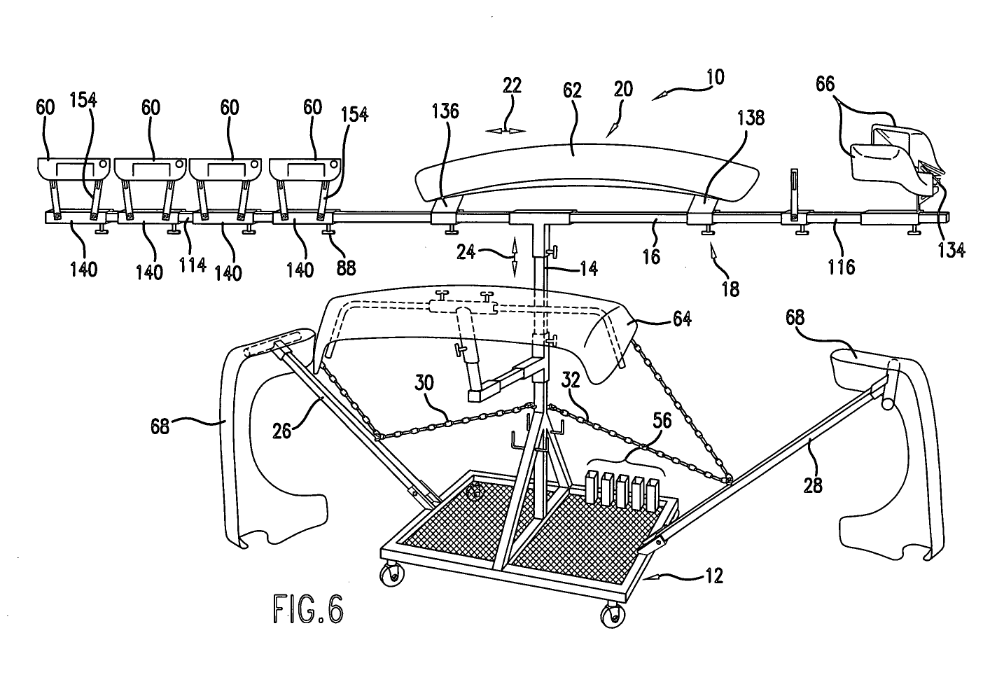

The stand 10 may be used to hold vehicle parts 20 from any type of vehicle for painting. For example, the stand 10 may be used to hold vehicle parts 20 of motorcycles, automobiles, golf carts, ATV's, boats, or airplanes. FIG. 5 shows one exemplary embodiment of the stand 10 configured for receiving automobile parts. Here, an automobile mirror fixture 134 is selectively positionable onto the second section 116 of the support member 16 and fixed thereon by a wing nut 88. The automobile mirror fixture 134 has a vertically extending post and a pair of V-shaped elements that extend therefrom and have a plurality of slots defined therein. One or more mirrors 66, as shown in FIG. 6, may be bolted onto the automobile mirror fixture 134 to be attached to the stand 10. Here, the bolts may be disposed through the slots in the automobile mirror fixture 134 and into the mirror 66 for retaining the mirror 66 thereon.

Referring back to FIG. 5, a spoiler fixture 136 is selectively positionable on the first section 114 of the support member 16, and a spoiler fixture 138 is selectively positionable onto the second section 116 of the support member 16. Wing nuts 88 may be used to fix the position of the spoiler fixtures 136 and 138 onto the support member 16. The spoiler fixtures 136 and 138 have an angled portion that extends at an angle in the vertical direction 24. A plurality of holes are disposed through the spoiler fixtures 136 and 138 for use in receiving bolts that enable a spoiler 62 of the vehicle to be attached thereon as shown in FIG. 6. The spoiler fixtures 136 and 138 are angled with respect to the vertical direction 24 in order to allow the spoiler 62 to be likewise angled. In this manner, the surface of the spoiler 62 that is to be painted is not flat and thus receives less “dirt” while painting. However, in accordance with other exemplary embodiments, the spoiler fixtures 136 and 138 may be oriented at any angle in order to hold the spoiler 62 onto the stand 10.

A door handle fixture 140 is located on the first section 114 of the support member 16 and may be selectively positionable therewith. A plurality of posts 154 are located on the door handle fixture 140 and may be pivoted to a desired location. The posts 154 of the door handle fixtures 140 define a slot through which a bolt or other fastener may be disposed in order to hold one or more vehicle parts 20 such as door handles 60 of an automobile as shown in FIG. 6. It is to be understood, however, that other objects may be held on the door handle fixtures 140 for painting.

FIG. 5 also shows the stand 10 as including a bumper fixture 156. The bumper fixture 156 includes a T-bracket 142 that is selectively positionable along the length of the vertical member 14. The location of the T-bracket 142 may be fixed through use of a wing nut 88. A bar 144 is included and is received within the T-bracket 142. The bar 144 extends away from the vertical member 14 and has an angled bracket 146 received on one end thereof. Another bar 148 is selectively positionable along the length of a portion of the angle bracket 146 so as to extend the bumper fixture 156 upwards in the vertical direction 24 of the stand 10. On one end of the bar 148, a pair of bumper supports 150 and 152 are received. The positioning and fixing of the bumper supports 150 and 152 may be accomplished through wing nuts 88.

The bumper fixture 156 provides a support for holding a bumper 64 of a vehicle for painting. As the bumper 64 will be supported a distance away from the vertical member 14, it may be desirable in some exemplary embodiments to provide additional weight on the opposite side of the vertical member 14. This may be accomplished, for example, by locating the holders 56 on an edge of the base 12 as shown. Additionally, other fixtures 18 that are not being used may be held by the holders 56 so as to provide additional counterweight.

The chains 30 and 32 may be connected to the bumper 64 to pull and help properly locate the bumper 64 on the bumper fixture 156. However, it is to be understood that in other exemplary embodiments the chains 30 and 32 need not be attached to the bumper 64. The bumper 64 may be fixed to the bumper fixture 156 or may simply lie thereon so as to be supported for painting.

FIG. 6 shows the stand 10 configured for receiving and holding a plurality of automobile parts 20. As shown, four door handles 60, one spoiler 62, one bumper 64, and two mirrors 66 are supported by the stand 10. In addition, the stand 10 is also shown as holding a pair of fenders 68. One of the fenders 68 is retained on the first pivotable member 26 and the other fender 68 is retained on the second pivotable member 28. The stand 10 having the aforementioned vehicle parts 20 may be moved into a paint booth and all of the vehicle parts 20 may be painted at one time. The stand 10 thus allows for a plurality of vehicle parts 20 to be held and painted without having to interrupt the painting process in order to detach and reattach various vehicle parts 20. The stand 10 may be used to hold vehicle parts 20 that are for different vehicles at the same time. For example, one or more automotive parts along with one or more motorcycle parts may be retained on the stand 10 at the same time.

The stand 10 may be variously configured in accordance with yet other exemplary embodiments. For example, portions of the stand 10 may pivot, rotate, or remain fixed with respect to one another. Additionally, any number of fixtures 18 may be employed for use in holding various vehicle parts 20. Still further, the stand 10 may be configured with anywhere from one to five vertical members 14 and anywhere from one to five support members 16 for use in holding the fixtures 18 onto which the vehicle parts 20 will be attached.

It should be understood that the present invention includes various modifications that can be made to the embodiments of the stand 10 for holding the vehicle parts 20 described herein as come within the scope of the appended claims and their equivalents.

What is claimed:

1. A stand for supporting vehicle parts for painting, comprising:
a base;
a vertical member attached to said base;
a support member attached to said vertical member; and
a plurality of fixtures attached to said support member and configured for holding a plurality of vehicle parts in relation to one another such that the vehicle parts are oriented as if in an assembled state.

2. The stand of claim 1, wherein said fixtures are spaced with respect to one another so as to be configured for holding the plurality of vehicle parts in relation to one another such that the vehicle parts are oriented and spaced with respect to one another as if in an assembled state.

3. The stand of claim 1, wherein said support member has an elongated length in the horizontal direction.

4. The stand of claim 1, further comprising first and second pivotable members pivotably attached to said base such that said first and second pivotable members are capable of being pivoted with respect to said base, and wherein at least one fixture is attached to each of said first and second pivotable members for use in holding the vehicle parts.

5. The stand of claim 4, further comprising:
a first chain attached to said first pivotable member and said vertical member for restricting pivoting of said first pivotable member away from said vertical member; and
a second chain attached to said second pivotable member and said vertical member for restricting pivoting of said second pivotable member away from said vertical member.

6. The stand of claim 1, wherein said support member is non-pivotably attached to said vertical member such that said support member and said vertical member maintain a fixed pivotable relationship with respect to one another.

7. The stand of claim 1, further comprising a plurality of vehicle parts held by said plurality of fixtures, wherein said plurality of vehicle parts are for a motorcycle and include at least a tank, a side fairing, a front fairing, and a rear section.

8. The stand of claim 1, further comprising:
a first intermediate member attached to said vertical member and located between said base and said support member, wherein a fixture is attached to said first intermediate member and is configured for holding one of the plurality of vehicle parts in relation to one another such that the vehicle parts are oriented as if in an assembled state; and
a second intermediate member attached to said vertical member and located between said base and said support member, wherein a fixture is attached to said second intermediate member and is configured for holding one of the plurality of vehicle parts in relation to one another such that the vehicle parts are oriented as if in an assembled state.

9. The stand of claim 1, further comprising a plurality of holders attached to said base, and wherein said base has a grate located thereon.

10. The stand of claim 1, wherein said plurality of fixtures are adjustable on said support member.

11. A stand for supporting a vehicle part for painting, comprising:
a base;
a vertical member attached to said base such that the orientation of said vertical member is fixed with respect to said base;
a support member attached to said vertical member such that the orientation of said support member is fixed with respect to said base and said vertical member, wherein said support member has an elongated length in the horizontal direction; and
a plurality of fixtures attached to said support member and configured for holding a vehicle part for painting.

12. The stand of claim 11, wherein said plurality of fixtures are configured for holding a plurality of vehicle parts in relation to one another such that the vehicle parts are oriented as if in an assembled state.

13. The stand of claim 12, wherein said plurality of fixtures are spaced with respect to one another so as to be configured for holding the plurality of vehicle parts in relation to one another such that the vehicle parts are oriented and spaced with respect to one another as if in an assembled state.

14. The stand of claim 11, further comprising vehicle parts that are held by said plurality of fixtures, wherein said vehicle parts are two mirrors, four door handles, two fenders, one bumper, and one spoiler.

15. The stand of claim 11, wherein the length of said support member in the horizontal direction is adjustable such that said support member is capable of being adjusted while maintaining the same orientation with respect to said base and said vertical member.

16. The stand of claim 11, further comprising a plurality of vehicle parts held by said plurality of fixtures, wherein said plurality of vehicle parts are for a motorcycle and include at least a tank, a side fairing, a front fairing, and a rear section.

17. The stand of claim 11, further comprising first and second pivotable members pivotably attached to said base such that said first and second pivotable members are capable of being pivoted with respect to said base, and wherein at least one fixture is attached to each of said first and second pivotable members for use in holding the vehicle parts.

18. The stand of claim 11, further comprising:
a first intermediate member attached to said vertical member and located between said base and said support member, wherein a fixture is attached to said first intermediate member and is configured for holding a vehicle part in combination with one of said fixtures on said support member; and
a second intermediate member attached to said vertical member and located between said base and said support member, wherein a fixture is attached to said second intermediate member and is configured for holding a vehicle part in combination with one of said fixtures on said support member.

19. The stand of claim 18, wherein the length of said first and second intermediate members is adjustable.

20. A stand for supporting vehicle parts for painting, comprising:
a base;
a vertical member attached to said base such that the orientation of said vertical member is fixed with respect to said base;
a support member attached to said vertical member such that the orientation of said support member is fixed with respect to said base and said vertical member;
a first intermediate member attached to said vertical member and located between said base and said support member;
a second intermediate member attached to said vertical member and located between said base and said support member;
a plurality of fixtures attached to said support member, said first intermediate member, and said second intermediate member, and wherein said fixtures are configured for holding a plurality of vehicle parts in relation to one another such that the vehicle parts are oriented as if in an assembled state.
